(19) United States
(12) Patent Application Publication
(10) Pub. No.: US 2021/0129226 A1
(43) Pub. Date: May 6, 2021

(54) METHOD FOR ADDITIVELY MANUFACTURING A THREE-DIMENSIONAL COMPONENT AND METHOD FOR CALCULATING A SCANNING STRATEGY FOR THE CORRESPONDING CONTROL OF A SYSTEM FOR ADDITIVELY MANUFACTURING A THREE-DIMENSIONAL COMPONENT

(71) Applicant: Amsis GmbH, Bremen (DE)

(72) Inventor: Vasily Ploshikhin, Bremen (DE)

(73) Assignee: Amsis GmbH, Bremen (DE)

(21) Appl. No.: 16/500,175

(22) PCT Filed: Apr. 5, 2018
(86) PCT No.: PCT/EP2018/000158

§ 371 Date: Oct. 2, 2019

(30) Foreign Application Priority Data
Apr. 6, 2017 (DE) 10 2017 107 364.7

(51) Int. Cl. B22F 10/85; B22F 10/28; B33Y 10/00; B33Y 30/00; B33Y 50/02; B29C 64/393; B29C 64/153; B29C 64/282; B22F 12/45

(52) U.S. Cl. CPC B22F 10/85; B22F 10/28; B33Y 10/00; B33Y 30/00; B22F 12/45; B29C 64/393; B29C 64/153; B29C 64/282; B33Y 50/02

(57) ABSTRACT

A method and system for additively manufacturing a three-dimensional component from multiple component layers (Li, Lk) by repeated incremental addition in layers of a metallic component starting material, and in incremental, shaping consolidation of the component starting material by respectively selective melting and/or sintering by means of an amount of heat introduced by at least one energy source according to a scanning strategy, the method including dividing each component layer into segments, wherein the division of a component layer into segments, the time sequence of the creation of individual segments, the layout of the scanning vectors within a segment, and/or the time sequence of the scanning vectors within a segment in the creation of respective segmented component layers takes place on the basis of a determined local heat dissipating capability or on the basis of a function of the same in a respective component layer.

### CROSS-REFERENCE TO RELATED APPLICATIONS

This application is the US National Phase of and claims the benefit of and priority on International Application No. PCT/EP2018/000158 having an international filing date of 5 Apr. 2018, which claims priority on German Patent Application No. 10 2017 107 364.7 having a filing date of 6 Apr. 2017.

### BACKGROUND OF THE INVENTION

### Technical Field

The present invention relates to a method for additively manufacturing a three-dimensional component from multiple component layers by repeated incremental addition, in particular in layers, of a component starting material, in particular a metallic component starting material, in the form of a powder, wire or strip, and, in particular incremental, shaping consolidation by respectively selective melting and/or sintering of the component starting material by means of an amount of heat introduced by at least one energy source, in particular locally, according to a scanning strategy, wherein the method comprises dividing each component layer into segments, and relates to a method for calculating the trajectories and time sequence of heat inputs for the corresponding control of a system for additively manufacturing a three-dimensional component.

In particular, it concerns additive manufacturing methods in which the energy input, in particular heat input, takes place locally.

“Component” is intended also to mean a component including a building plate (baseplate) and supporting structure(s). Moreover, the term “component” is also intended to include a component set, such as for example a construction manufactured in a building job in a building space, which may for example consist of multiple, for example identical, individual components.

An electric arc, a plasma or a plasma jet, a laser or electron beam or the like may be used for example as (an) energy source(s). The additive manufacturing method may be in particular a beam-based additive manufacturing method, such as for example selective laser melting or selective electron beam melting. The component starting material may be produced from metal, plastic or ceramic. It may also be for example a powder, a powder filling wire or filling strip.

The additive manufacturing method, which is also referred to as a generative manufacturing method, may be for example arc, plasma, laser and electron-beam build-up welding and build-up welding in general, in particular powder build-up welding, laser and electron-beam melting, laser sintering and all other methods in which material is selectively applied in molten form for generating a component.

Conceivable as material build-up methods are for example powder or wire build-up welding in the case of additive manufacturing of metallic materials, or for example fused deposition modeling technologies for the additive generation of plastic components.

### Prior Art

In today's systems for the additive manufacturing of three-dimensional components, the strategy of the energy input, in particular the heat input, is mainly designed purely geometrically. This involves dividing the layer geometry to be generated into individual, normally rectangular segments (often also known as “islands” or “strips”). Within a segment, straight-line scanning vectors (exposure vectors) are laid out equidistantly, parallel to the segment bounds. The actual energy or heat input takes place for example by a laser along a scanning vector. With the aid of a scanning device, multiple scanning vectors are created one after the other within a segment. In other words, the amount of energy or heat is introduced by means of a scanning strategy. The term “scanning strategy” is intended here to mean primarily the description of the consolidation of a defined region in a layer of a component starting material with the already generated (consolidated) part of the component by fusing, welding, sintering or solidifying by means of at least one moved (in particular point-form) energy source, while taking into account deflecting displacements or scanning displacements (scanning patterns) and beam parameters and also the time dependence of the deflecting displacements and direction dependence of the deflecting displacements for creating desired component and microstructure properties. The scanning strategy comprises a scanning pattern. This is the geometrical description of the deflecting displacements or connecting lines of successive energy inputs, if for example pulsing is used, for solidifying the component contour and/or the component cross section by means of at least one beam or some other heat source.

According to DE 100 42 134 C2, a better uniformity of the energy or heat input is achieved by selecting the position of the individual segments on the basis of the random principle in the generation of a component layer.

During an additive manufacturing method, accumulations of heat and in particular local overheating (“hotspots”) may occur due to the layer-by-layer build-up and the local introduction of energy, in particular in the vicinity of boundaries of the component. This may lead to an impairment of the component quality, and in particular of the surface of the component, as a result of sintering accretion effects or undesired local deformations (distortion).

### BRIEF SUMMARY OF THE INVENTION

The present invention is consequently based on the object of providing a method for additively manufacturing a three-dimensional component with which components can be produced in better quality.

According to the invention, this object is achieved in the case of the method of the generic type in that the division of a component layer into segments and/or the time sequence of the creation of individual segments and/or the layout of the scanning vectors within a segment and/or the time sequence of the scanning vectors within a segment in the creation of respective segmented component layers (Li, Lk) takes place on the basis of a determined local heat dissipating capability, in particular determined in a simulation-based manner, or on the basis of a function of the same in a respective component layer. The determination of the local heat dissipating capability is described in DE 102016120998.8 A1, the disclosure of which in this respect is fully included herein by reference.

In particular, it is a computer-implemented method.

The local heat dissipating capability characterizes the capability of a component region to transport heat away into the interior of the component.

According to one particular embodiment, it may be provided that a respective component layer is segmented into polygonal segments, in particular rectangular or hexagonal segments.

Advantageously, for the segmentation of a respective component layer, isolines or quasi-isolines or points of an isoline of the determined local heat dissipating capability are at least partly selected as the bounding delimitation of the segments. Quasi-isolines are intended to mean lines that are very close to being isolines. The created consolidation traces are in this case cooled down more uniformly, which will lead to reducing the local internal stresses and the local distortion. As a result of the same thermal conditions to be expected along the entire scanning vectors, better local process stability (for example maintenance of the constant melt bath in selective laser melting) is ensured.

In particular, it may be provided in the method that part of the bounding delimitation of the segments is chosen as aligned in the direction of a gradient of the heat dissipating capability or substantially perpendicular to the isolines or quasi-isolines of the local heat dissipating capability.

Advantageously, one of the values of the local heat dissipating capability within the respective segment, in particular an average value of the local heat dissipating capability, in each of the segments is used as a reference value of the local heat dissipating capability. The level of the local heat dissipating capability within a segment may be characterized (represented) with the aid of a number/a value. In the general case, the value of the local heat dissipating capability at different points of a segment is not constant and changes within a segment. For characterizing the level of the local heat dissipating capability, one of the values of the local heat dissipating capability within the respective segment may be selected. This value may be for example an average value of the local heat dissipating capability. A minimum or maximum value or a combination thereof may also be selected as a representative value, referred to here as a reference value.

In particular, it may in this case be provided that the sequence of the creation of individual segments is chosen on the basis of the reference values of the local heat dissipating capability.

In particular, it may in this case be provided that the segments are created starting from segments with a low reference value of the local heat dissipating capability progressively to segments with a higher reference value of the local heat dissipating capability.

For example, it may be provided that the time interval is reduced in the transition between successive segments.

Alternatively, according to one particular embodiment, the heat input is increased by an increase of the power output or reduction of the speed of the heat source in the transition to the next successive segment.

According to a further particular embodiment, the segments are created starting from segments with a higher reference value of the local heat dissipating capability progressively to segments with a lower reference value of the local heat dissipating capability.

In particular, it may in this case be provided that the time interval is increased in the transition between successive segments.

According to a further particular embodiment, the heat input is reduced by a reduction of the power output or an increase of the speed of the heat source in the transition to the next successive segment.

In a further particular embodiment, the segments of a component layer are divided into at least two groups according to the reference value of the local heat dissipating capability in the respective segments.

In particular, it may in this case be provided that a respective group of segments is formed from those segments of which the reference value of the local heat dissipating capability lies within a specific interval between two constant limit values of the local heat dissipating capability.

In turn, it may in this case be provided that, for each group of segments, a reference value, in particular an average value, of the local heat dissipating capability is determined.

Furthermore, it may in this case be provided that the sequence for creating individual groups is chosen on the basis of the reference value of the local heat dissipating capability of the respective group.

In this way it may be provided that the groups are created starting from groups with a low reference value of the local heat dissipating capability progressively to groups with a higher reference value of the local heat dissipating capability.

In particular, the time interval is reduced in the transition between successive groups of segments.

In a further particular embodiment, the heat input is increased by an increase of the power output or reduction of the speed of the heat source in the transition to the next successive group of segments.

According to a further particular embodiment, the groups are created starting from groups with a higher reference value of the local heat dissipating capability progressively to groups with a lower reference value of the local heat dissipating capability.

In particular, it may in this case be provided that the time interval is increased in the transition between successive groups.

According to a further particular embodiment, the heat input is reduced by a reduction of the power output or an increase of the speed of the heat source in the transition to the next successive group of segments.

Advantageously, a middle point is determined in each of the segments.

In particular, it may in this case be provided that the sequence of the creation of individual segments is chosen on the basis of the position of the middle point of the respective segment within the respective component layer and of the reference value of the local heat dissipating capability in the respective segment.

In this case it may be provided that the first segment to be created in a component layer or in a group of segments is selected randomly or on the basis of a minimum or maximum reference value of the local heat dissipating capability or on the basis of a minimum or maximum value of the area of the segment.

Furthermore, it may be provided that the sequence for the second and every further segment to be created in a component layer or in a group of segments is formed on the basis of a distance from the middle points of the segments.

In particular, it may in this case be provided that a segment of which the middle point is at a maximum distance from the middle point of the last created segment is selected as the next segment to be created from the not yet created segments of a component layer or a group of segments.

In particular, it may in this case be provided that, if the middle points of a number of segments are the same distance away from the middle point of the last created segment, the next segment to be created is selected randomly or on the basis of the minimum or maximum reference value of the local heat dissipating capability.

Expediently, the component layer is created with the aid of a number of energy sources acting at the same time at different locations of the component layer, in particular with a number of lasers or with a light source split between different locations.

In particular, it may in this case be provided that at least one pair of successive segments is created at the same time from the determined sequence of the creation of the segments with the aid of at least two different energy sources.

According to a further particular embodiment, scanning vectors in a respective segment are laid out, preferably equidistantly from one another, along the isolines of the local heat dissipating capability.

Advantageously, in each of the segments the direction of the gradient of the local heat dissipating capability, preferably at the middle point of the respective segment, is used as a reference direction of the gradient of the local heat dissipating capability. The gradient of the local heat dissipating capability is a vector. In the general case, the gradient of the local heat dissipating capability at different points of a segment is not constant, its direction changes within a segment. For characterizing the direction of the gradient within a segment, it may be required only to define a specific direction. For example, the direction of the gradient at the middle point of a segment, referred to here as the reference direction, may also be selected as a representative direction. An alternative designation of the representative direction would be “a reference direction”.

In particular, it may in this case be provided that the direction of the scanning vectors in a respective segment is laid out transversely to the reference direction of the gradient of the local heat dissipating capability.

Furthermore, it may be provided that in a respective segment an edge of this segment of which the normal vector has the smallest deviation from the reference direction of the gradient of the local heat dissipating capability is determined as the normal vectors of the other edges of this segment, and the scanning vectors are laid out parallel to this edge, preferably equidistanly. The scanning vectors are in this case laid out parallel to the edge that is inclined most transversely to the direction of the gradient.

Furthermore, the sequence of the scanning of the individual scanning vectors within a segment may be chosen on the basis of the reference direction of the gradient of the local heat dissipating capability.

In particular, it may in this case be provided that the offset between two successive scanning vectors within a segment takes place in a reference direction of the gradient of the local heat dissipating capability. Accordingly, first the lowermost scanning vector is created, then the next lowest, etc., successively from the bottom upward, in the direction of the gradient.

Moreover, it may be provided that the time interval between successive scanning vectors is successively shortened.

According to a further particular embodiment, the offset between two successive scanning vectors within a segment takes place counter to a reference direction of the gradient of the local heat dissipating capability.

Finally, it may be provided in the method that the time interval between successive scanning vectors is successively increased.

Furthermore, the present invention provides a method for calculating a scanning strategy for the corresponding control of a system for additively manufacturing a three-dimensional component, wherein the division of a component layer into segments and/or the time sequence of the creation of individual segments and/or the layout of the scanning vectors within a segment and/or the time sequence of the scanning vectors within a segment takes place on the basis of a determined local heat dissipating capability, in particular determined in a simulation-based manner, or on the basis of a function of the same in a respective component layer. This is then incorporated in the building job.

In the method, it may be provided individually or in any desired combinations that
a respective component layer (Li, Lk) is segmented into polygonal segments, in particular rectangular or hexagonal segments,
for the segmentation of a respective component layer (Li, Lk), isolines (I1, I2, I3) or quasi-isolines or points of an isoline of the determined local heat dissipating capability are at least partly selected as the bounding delimitation of the segments,
part of the bounding delimitation of the segments (S1, S2, S3, . . . , S12) is chosen as aligned in the direction of a gradient (G1, G2) of the heat dissipating capability or substantially perpendicular to the isolines or quasi-isolines of the local heat dissipating capability,
one of the values of the local heat dissipating capability within the respective segment, in particular an average value of the local heat dissipating capability, in each of the segments is used as a reference value of the local heat dissipating capability,
the sequence of the creation of individual segments is chosen on the basis of the reference values of the local heat dissipating capability,
the segments of a component layer are divided into at least two groups according to the reference value of the local heat dissipating capability in the respective segments,
a respective group of segments is formed from those segments of which the reference value of the local heat dissipating capability lies within a specific interval between two constant limit values of the local heat dissipating capability,
for each group of segments, a reference value, in particular an average value, of the local heat dissipating capability is determined,
the sequence of the creation of individual groups is chosen on the basis of the reference value of the local heat dissipating capability of the respective group,
in each of the segments, a middle point is determined,
the sequence of the creation of individual segments is chosen on the basis of the position of the middle point of the respective segment within the respective component layer and of the reference value of the local heat dissipating capability in the respective segment,
the first segment to be created in a component layer or in a group of segments is selected randomly or on the basis of a minimum or maximum reference value of the local heat dissipating capability or on the basis of a minimum or maximum value of the area of the segment,
the sequence for the second and every further segment to be created in a component layer or in a group of segments is formed on the basis of a distance from the middle points of the segments,
scanning vectors in a respective segment are laid out, preferably equidistantly from one another, along the isolines of the local heat dissipating capability,
in each of the segments the direction of the gradient of the local heat dissipating capability, preferably at the middle point of the respective segment, is used as a reference direction of the gradient of the local heat dissipating capability,
the direction of the scanning vectors in a respective segment is laid out transversely to the reference direction of the gradient of the local heat dissipating capability,
in a respective segment an edge of this segment of which the normal vector has the smallest deviation from the reference direction of the gradient of the local heat dissipating capability is determined as the normal vectors of the other edges of this segment, and the scanning vectors are laid out parallel to this edge, preferably equidistanly,
the sequence of the scanning of the individual scanning vectors within a segment is chosen on the basis of the reference direction of the gradient of the local heat dissipating capability.

Finally, the present invention also provides one or more computer-readable medium/media which comprise(s) commands which can be executed by computer and, when they are executed by a computer, make the computer carry out the methods of the appended claims.

Moreover, the present invention provides a system for additively manufacturing a three-dimensional component from multiple component layers by repeated incremental addition, in particular in layers, of a component starting material, in particular a metallic component starting material, in the form of a powder, wire or strip, and, in particular incremental, shaping consolidation of the component starting material by respectively selective melting and/or sintering by means of an amount of heat introduced by at least one energy source, in particular locally, according to a scanning strategy, comprising a building space housing with a building platform for supporting one or more component/components to be additively manufactured in a powder-bed-based manner, a layer preparation device for preparing respective powder layers on the building platform, an irradiating device for irradiating the respectively last-prepared powder layer on the building platform and a control device for controlling the irradiating device according to a method as claimed in one of the appended claims.

The invention focuses on rapid dissipation within the component of the energy introduced, which leads to at least one of the following advantages:
better temperature equalization within the component generated,
reduced risk of local overheating,
reduction of the internal stresses and distortion,
increase of the overall process stability,
more uniform distribution of component properties.

### BRIEF DESCRIPTION OF THE DRAWINGS

Further features and advantages of the invention emerge from the appended claims and the following description, in which a number of exemplary embodiments are explained in detail on the basis of the schematic drawings, in which:

FIG. 1 shows a schematic representation for explaining the definition of the local heat dissipating capability;

FIG. 2 shows a schematic representation for explaining terms;

FIG. 3 shows a schematic representation for explaining a method for additively manufacturing a three-dimensional component from multiple component layers by using multiple energy sources according to one particular embodiment of the present invention;

FIG. 4 shows a sectional view of an axially symmetrical component;

FIG. 5 shows a plan view of the component from FIG. 4;

FIG. 6 shows a local distribution Dᵢ, given by way of example, of the heat dissipating capability D^{loc} in a component layer Lᵢ of the component from FIG. 4;

FIG. 7 shows isolines I₁, I₂ and I₃ of the local distribution Dᵢ of the heat dissipating capability in a component layer Lᵢ from FIG. 6;

FIG. 8 shows a segmentation of a component layer Lᵢ of the component from FIG. 4 according to one particular embodiment of the present invention;

FIG. 9 shows a segmentation of a component layer Lᵢ of the component from FIG. 4 according to a further particular embodiment of the present invention;

FIG. 10 shows a sequence of a consolidation of the segments shown in FIG. 9 according to one particular embodiment of the present invention;

FIG. 11 shows a layout of scanning vectors within a segment according to one particular embodiment of the present invention;

FIG. 12 shows a layout of scanning vectors within a segment according to a further particular embodiment of the present invention;

FIG. 13 shows a segmentation of a component layer Lᵢ of the component from FIG. 4 according to a further particular embodiment of the present invention;

FIG. 14 shows a segmentation of a component layer Lᵢ of the component from FIG. 4 according to a further particular embodiment of the present invention;

FIG. 15 shows a merging of adjacent segments according to one particular embodiment of the present invention;

FIG. 16 shows a layout of bounds of segments according to one particular embodiment of the present invention;

FIG. 17 shows a segment S, which is obtained by the layout shown in FIG. 16;

FIG. 18 shows a segment Sq, which is obtained by modification of the segment S from FIG. 17;

FIG. 19 shows the creation of curved scanning vectors within a segment according to one particular embodiment of the present invention;

FIG. 20 shows a layout of scanning vectors within a segment according to one particular embodiment of the present invention;

FIG. 21 shows a symmetrical segmentation of a component layer Lᵢ of the component from FIG. 4;

FIG. 22 shows a sequence of the consolidation of individual segments of the segmentation from FIG. 21 according to one particular embodiment of the present invention;

FIG. 23 shows segmentations of a component layer Lᵢ of the component from FIG. 4 according to a further particular embodiment of the present invention;

FIG. 24 shows a linearization of a segmentation according to one particular embodiment of the present invention;

FIG. 25 shows an irregular segmentation of a component layer Lᵢ of the component from FIG. 4;

FIG. 26 shows a special case of the scanning of individual segments according to one particular embodiment of the present invention;

FIG. 27 shows a special case of the scanning of individual segments according to a further particular embodiment of the present invention in side view; and

FIG. 28 shows a plan view of the same.

### DETAILED DESCRIPTION OF PREFERRED EMBODIMENTS

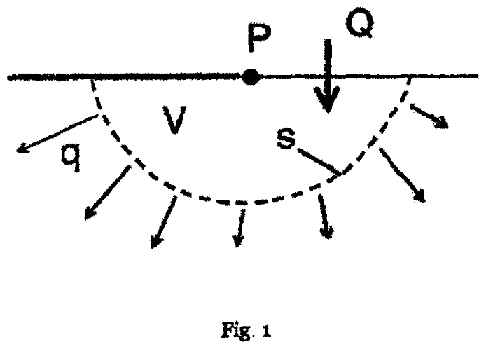

Generally, the heat dissipating capability D (“dissipation”) of the component layer is defined as an integral of the heat flux q [W/m²] over the surface S [m²] (see FIG. 1):

D= [symbol] _{S}qnds=∫_{V} div(q)dV=∫_{V} div(−λ grad(T))dV

n is the normal vector to the surface S; V is the volume considered, m³; T is the temperature, K; λ is the thermal conductivity, W/(mK).

The local heat dissipating capability can be calculated on the basis of the heat conduction equation:

$$D = {\int }_{V} div ( q ) = {\int }_{V} ( Q - c ρ \frac{\partial T}{\partial t} ) dV$$

Q is the power output of the heat source in the volume V, [W/m³]; c is the specific heat capacity, [J/(kgK)]; ρ is the density, [kg/m³]; t is the time, [s].

At a specific point P of the component (V→0), the local heat dissipating capability D^{loc} is then defined as follows:

$${D}^{loc} = div ( q ) = Q - c ρ \frac{\partial T}{\partial t}$$

The local heat dissipating capability depends not only on the properties of the material (heat conduction, heat capacity, density) and on the heat input. It is also strongly influenced by the boundary conditions, such as for example the local component geometry.

As the above statements show, consequently at least two possible independent ways of determining the local heat dissipating capability of a point of a component layer are to use

$$\begin{matrix}{D}^{loc} = div ( q ) = div ( - λ grad ( T ) ) or & ( 1 ) \\ {D}^{loc} = Q - c ρ \frac{\partial T}{\partial t} & ( 2 )\end{matrix}$$

for determining the local heat dissipating capability, while in both cases the local component geometry still has to be taken into account.

For the times in which a point of the component layer is purely cooling down, i.e. for the times in which the heat source is no longer acting at the point considered (power output of the heat source Q=0), the second of the aforementioned calculating ways provides an even simpler form of representation:

$${D}^{loc} = - c ρ \frac{\partial T}{\partial t}$$

This representation of the local heat dissipating capability allows an easy determination of the capability of a specific point to dissipate heat at a specific point in time. The higher the cooling-down rate at the point considered at a specific point in time, the higher the local heat dissipating capability. Generally, the temperature distribution and the cooling-down rate in the component, and accordingly the local heat dissipating capability, change over time. It is therefore advisable to integrate the local heat dissipating capability over a specific time and use the resultant value for the characterization of the heat dissipation at a specific point. Assuming the absence of a heat source, i.e. heat input=zero, a following value is obtained:

$${D}_{int}^{loc} = - {\int }_{{t}_{1}}^{{t}_{2}} c ρ \frac{\partial T}{\partial t} dt = - {\int }_{{t}_{1}}^{{t}_{2}} \frac{\partial H}{\partial t} dt = - Δ H$$

ΔH is the change of the enthalpy, J, in a time interval from t₁ to t₂.

Assuming the temperature-independent material properties, the local heat dissipating capability can be characterized by the changing of the temperature:

Dᵢₙₜ^{loc}=−ΔH=−cρΔT

Found to be a useful value for characterizing the local heat dissipating capability is a relative local heat dissipating capability, which represents a relationship between D^{loc}ᵢₙₜ to the initial temperature gradient:

$${D}_{rel}^{loc} = \frac{{D}_{int}^{loc}}{\frac{\partial T ( x , y , z , 0 )}{\partial z}}$$

All of the representations described above of the local heat dissipating capability (as a change of enthalpy or of temperature) can be easily determined in the course of a calculation of the temperature field (thermal calculation).

Indirect physical interpretation of the value of the local heat dissipating capability: the heat in an additive manufacturing method is normally mainly transported downward, from a generated component layer into the interior of the component. In this case, the value of a local heat dissipating capability indirectly indicates the amount of mass of the “cold” consolidated material there is under the specific point of the component layer. The more “cold” material mass there is under a specific point of a component layer, the higher the value of a local heat dissipating capability.

For a direct thermal calculation of the building-up process, a sequential thermal activation of all the component layers/segments would be necessary. Such a procedure would require correspondingly numerous time increments, and would involve a high computational effort.

According to one particular embodiment of the present invention, the determination of the local heat dissipation capacities can take place much more quickly by a simplified implementation of the numerical simulation. In this case, the entire component is calculated without thermal activation of individual component layers/segments. Such a simplified simulation will lead to a drastic reduction of the required computing times (the larger the component, the greater the saving in computing time becomes).

As an initial condition, in this or another embodiment an “artificial” temperature distribution, with a temperature rising in the building-up direction (z direction), is used. The initial temperature gradients T in the x and y directions are set to zero:

$$\{ \begin{matrix}\frac{\partial T ( x , y , z , 0 )}{\partial z} > 0 \\ \frac{\partial T ( x , y , z + Δ z , 0 )}{\partial z} \geq \frac{\partial T ( x , y , z , 0 )}{\partial z} \\ \frac{\partial T ( x , y , z , 0 )}{\partial x} = \frac{\partial T ( x , y , z , 0 )}{\partial y} = 0\end{matrix}$$

Such a temperature distribution as an initial condition imitates the temperature distribution in the actual building-up process. This distribution ensures for each component layer that the heat flux at the beginning of the calculation takes place exclusively downward.

A particularly effective variant of the aforementioned initial condition represents a constant temperature gradient in the building-up direction:

$$\{ \begin{matrix}\frac{\partial T ( x , y , z , 0 )}{\partial z} = const > 0 \\ \frac{\partial T ( x , y , z , 0 )}{\partial x} = \frac{\partial T ( x , y , z , 0 )}{\partial y} = 0\end{matrix}$$

The constant initial temperature gradient in the building-up direction, predefined for each point of the component, and consequently also for each component layer, has the same zero value of the local heat dissipating capability:

$$\begin{matrix}{D}^{loc} ( x , y , z , 0 ) = & div ( q ( x , y , z , 0 ) ) = \\ & div ( - λ grad ( T ( x , y , z , 0 ) ) = \\ = & div ( - λ ( \frac{\partial T ( x , y , z , 0 )}{\partial x} + \frac{\partial T ( x , y , z , 0 )}{\partial y} + \\ & \frac{\partial T ( x , y , z , 0 )}{\partial z} ) ) = \\ = & div ( - λ ( const + 0 + 0 ) ) = o\end{matrix}$$

The zero value of the local heat dissipating capability for each point of the component represents a convenient starting basis for representing the subsequent changes of the local heat dissipating capability at each point of the component.

In general—as described above on the basis of an exemplary embodiment—the initial temperature distribution is simply assumed. For a more accurate determination of the initial temperature distribution, both simplified solutions, such as for example a quick 1- or 2-dimensional calculation of the temperature field during the building-up process, and experimental measurements may be used.

Apart from the initial conditions, boundary conditions may also be defined. Some particularly advantageous boundary conditions are to be singled out for special mention:

1) Constant heat flux over the entire calculation area
In the case of this variant of the boundary conditions, the heat flux at the top boundary q₍ₜₒₚ₎ and at the bottom boundary q_{(bottom)} is constant and corresponds to the given initial constant temperature gradient grad (T(x, y, z, 0)) in the component:

qₜₒₚ=q_{bottom}=−λ grad(T(x,y,z,0))=const
The other boundaries of the component are thermally insulated, that is to say that the heat flux over time always has a value of zero.
In the case of a constant temperature gradient, the initial local heat dissipating capability has a value of zero at every point of the calculation area (the reasoning for this is indicated above).
With the same top and bottom surface area of the calculation area, this boundary condition ensures a flow of the same amounts of energy through the entire calculation area. After a certain time for reaching a steady state of the temperature field, that is to say after a redistribution of the temperature, the “new” temperature remains stable at every point. Thus, the values of the local heat dissipating capability also stabilize themselves. It is generally advisable to arrange for calculation to be performed up to this steady or almost steady state.
This variant of the boundary conditions is particularly suited for the determination of the local heat dissipating capability in local regions of the component. By such local calculations, for example the accumulations of heat in the vicinity of a channel or a defect, such as for example a pore or other undesired void, are investigated. The local calculations of this type may be used in the course of a monitoring system (see below).
   2) Full thermal insulation of the entire calculation area
A full thermal insulation of the entire calculation area represents a variant of the boundary conditions that is very well suited for the determination of the local heat dissipating capability in the components (in the course of the so-called global calculations (thermal calculation of the component as a whole)). A calculation up to a first maximum of the temperature change (and not up to a steady or almost steady state) may then be sufficient.

The field of the local heat dissipating capability may be determined numerically by a thermal calculation for a specific component (in advance).

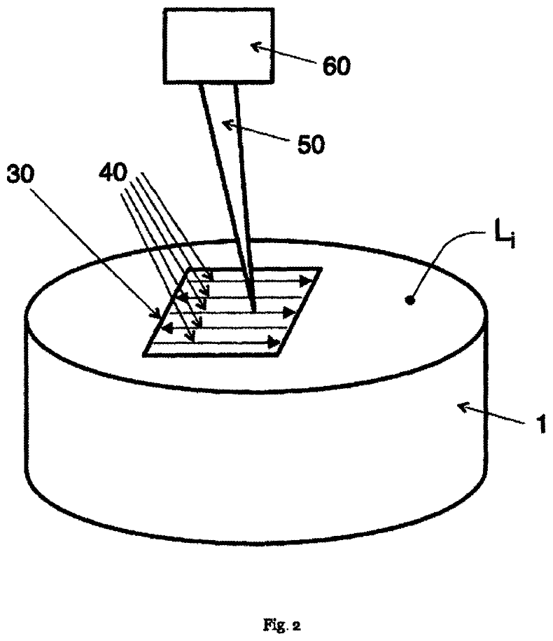

FIG. 2 serves for explaining the terms “component”, “component layer”, “segment” and “scanning vector”. In the case of a method for the additive manufacturing of a three-dimensional component 1, the component is built up layer by layer with the aid of one or more energy sources (as part of an irradiating device), in the present example by means of a laser (not shown). The laser delivers a laser beam 50, which in this example is directed by a scanner 60. A component layer Lᵢ is divided into segments, of which only one is shown and is provided with the reference numeral 30. The segment 30 in this example comprises five scanning vectors 40.

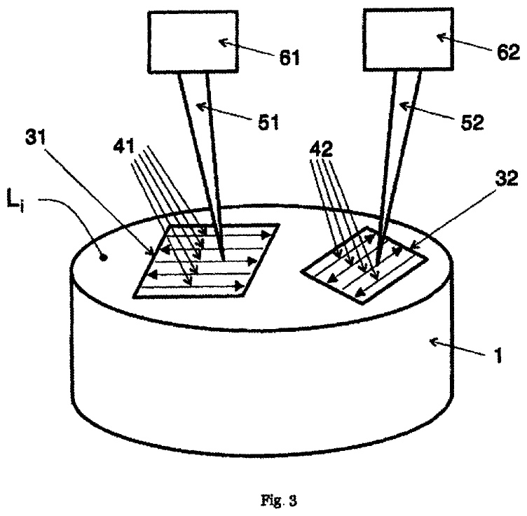

In FIG. 3, a system with two energy sources, in this example in each case a laser (not shown), is shown. Each of the two lasers delivers a respective laser beam 51 or 52. In this example, two different segments, specifically the segments 31 and 32, are generated at the same time by the two laser beams 51 and 52. The scanning vectors 41 and 42 in the two segments 31 and 32 are aligned alternately oppositely to one another, exactly as in the example shown in FIG. 2.

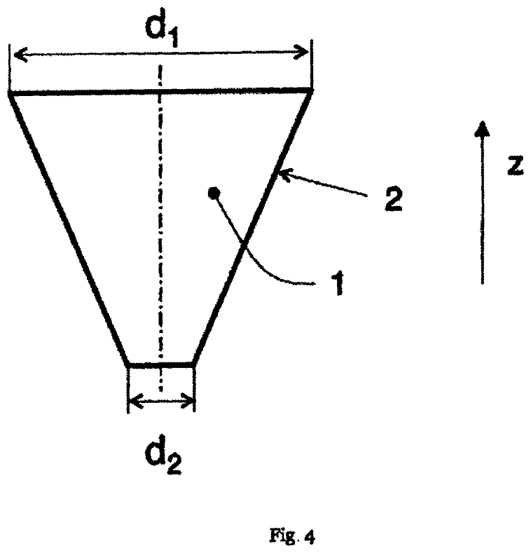

FIG. 4 shows a side view of an axially symmetrical component 1 with an outer surface 2. It is in this example a frustoconical component. The component 1 has an upper diameter d₁ and a lower diameter d₂. The building-up direction is indicated by z.

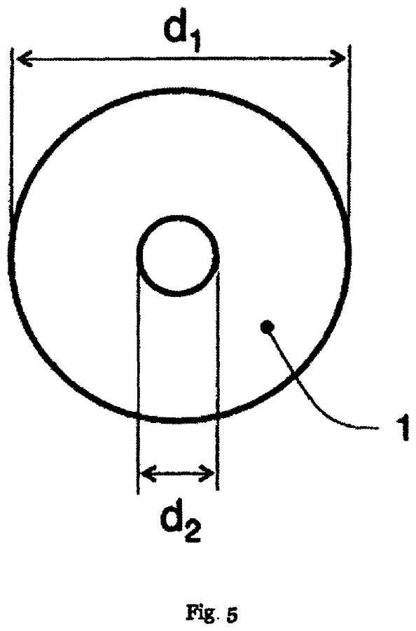

FIG. 5 shows a plan view of the component 1 from FIG. 4.

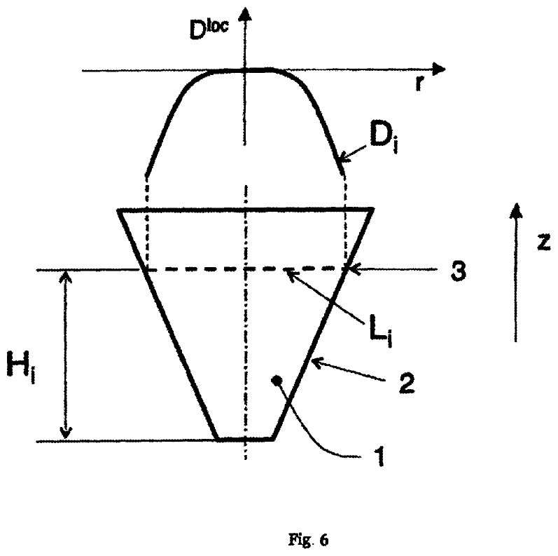

In FIG. 6, a local distribution Dᵢ of the heat dissipating capability D_{loc} in a component layer Lᵢ of the component 1 from FIG. 4 is shown. The component layer Lᵢ is at a height Hᵢ. Since the component 1 is symmetrical, the field of the heat dissipating capability is also symmetrical. The outer boundary of the component layer Lᵢ, which lies on the outer surface 2, is indicated by the reference numeral 3. The surface 2 forms a downward barrier to the free flow of the heat (counter to the building-up direction z). The closer to the boundary 3 in the component layer Lᵢ, the more the heat accumulates, and the lower the heat dissipating capability. In the middle region (within the diameter d₂), the downward heat flux is not prevented. Therefore, the values of the local heat dissipating capability are equal to zero.

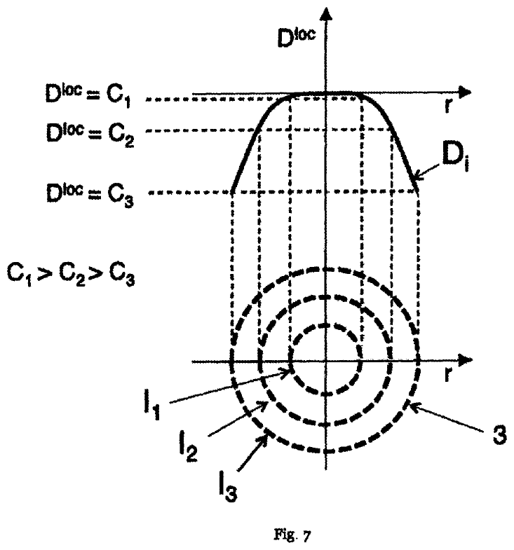

FIG. 7 shows associated isolines I₁, I₂ and I₃ of the local heat dissipating capability Dᵢ in the component layer Lᵢ from FIG. 6 with the boundary 3. The values C₁, C₂ and C₃ are constants. On account of the symmetry of the component 1, the isolines are also symmetrical. The isoline I₃ and the outer boundary 3 of the component layer Lᵢ are identical on account of the symmetry.

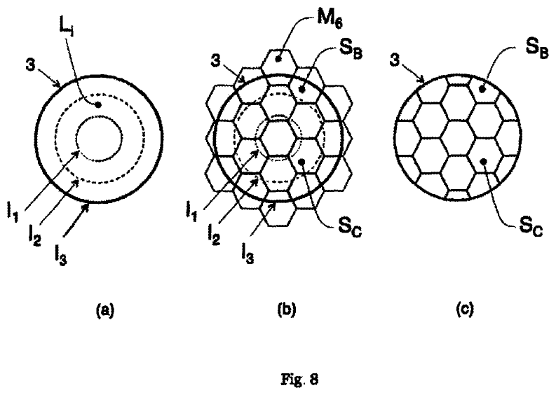

FIG. 8 then shows a segmentation of a component layer Lᵢ with hexagonal segments. To be more precise, FIG. 8 (a) shows the component layer Lᵢ with isolines I₁, I₂ and I₃, FIG. 8 (b) shows a pattern M₆ with segments of the same hexagonal geometry, the segments SB being segments that intersect the boundary 3 (“boundary segments”), while the segments S_{c} are segments that lie completely in the interior of the segment (“core segments”), and FIG. 8 (c) shows the final segmentation of the component layer.

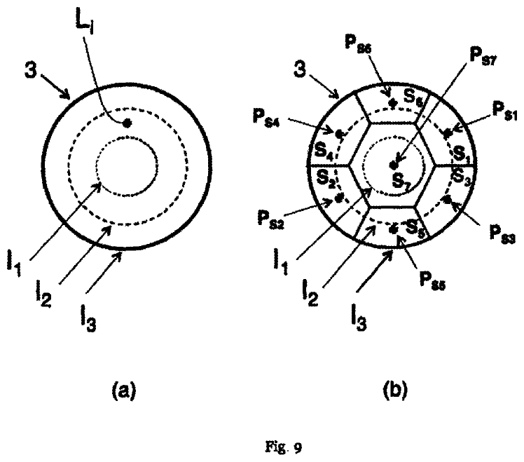

In FIG. 9, a simpler segmentation of the component layer Lᵢ is shown. To be more precise, FIG. 9 (a) shows the component layer Lᵢ with isolines I₁, I₂ and I₃ and FIG. 9 (b) shows the segments S₁, S₂, S₃, S₄, S₅ and S₆ and their middle points P_{S1}, P_{S2}, P_{S3}, P_{S4}, P_{S5} and P_{S6}, respectively.

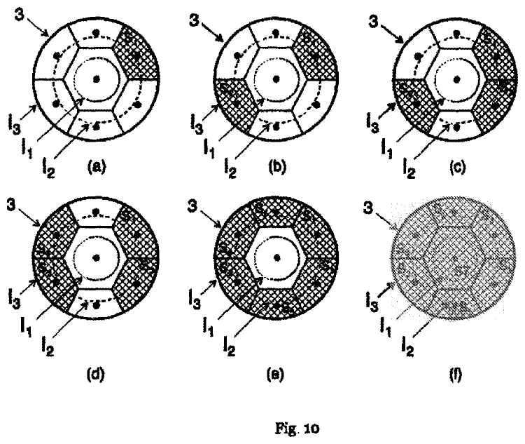

In FIG. 10, a sequence for the consolidation of the segments S₁ to S₆ of FIG. 9 is then shown by way of example. First, a region with the lowest heat dissipating capability (with the middle points) between the isolines I₁ and I₂ is consolidated. S₁ is randomly generated as the first segment in this region (see FIG. 10 (a)).

Then, S₂ is generated as the second segment. The middle point of S₂ lies in the same region between I₂ and I₃ as the middle point of S₁ and is furthest away from the middle point of S₁ (see FIG. 10 (b)).

Then, the segment S₃ is scanned as the third segment. It is one of two segments equally furthest away from S₂ in the region of the lowest heat dissipating capability. S₃ is randomly selected from these two segments (see FIG. 10 (c)).

S₄ is generated as the fourth segment. It is a free segment furthest away from S₃ in the region of the lowest heat dissipating capability (see FIG. 10 (d)).

First, S₅ is generated as the free segment furthest away from S₄ in the region of the lowest heat dissipating capability. Then, a scanning of the last remaining free segment in the region of the lowest heat dissipating capability (S₆) takes place (see FIG. 10 (e)).

Lastly, the segment S₇ is consolidated. It is the only segment in the region of the higher heat dissipating capability (lies completely within I₁) (see FIG. 10 (f)).

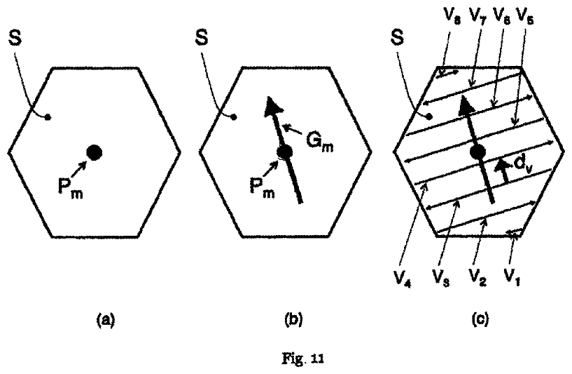

In FIG. 11 (a) to (c), a layout of the scanning vectors within a segment is shown by way of example. A middle point Pₘ in a segment S is defined as a “center of mass” (see FIG. 11 (a)). This is followed by an alignment of a gradient Gₘ of the heat dissipating capability at the middle point Pₘ (see FIG. 11 (b)). Finally, in this example equidistant scanning vectors 5 are laid transversely to the alignment of the gradient Gₘ of the heat dissipating capability (see FIG. 11 (c)). In this example, the sequence of the scanning vectors V₁ to V₈ is formed by an offset in the direction of the gradient. The vector dv denotes the offset between the two parallel scanning vectors V₃ and V₄.

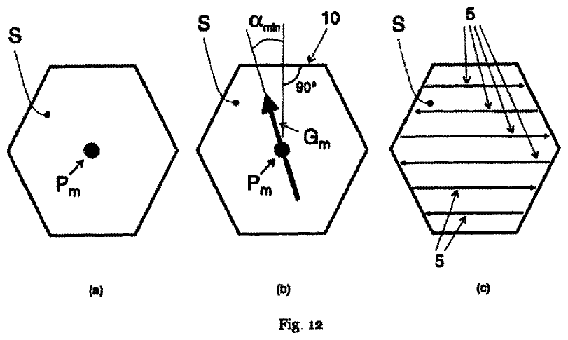

FIG. 12 shows a layout of the scanning vectors within a segment according to a further particular embodiment of the present invention. A middle point Pₘ in a segment S is defined as the “center of mass” (see FIG. 12 (a)). This is followed by an alignment of a gradient Gₘ of the heat dissipating capability at the middle point Pₘ (see FIG. 12 (b)). An edge 10 of the segment S is defined with a minimum angle αₘᵢₙ with respect to the gradient Gₘ of the heat dissipating capability (see FIG. 12 (b)). Finally, a laying of in this example equidistant scanning vectors 5 parallel to the alignment of the edge takes place with the minimum angle with respect to the gradient Gₘ.

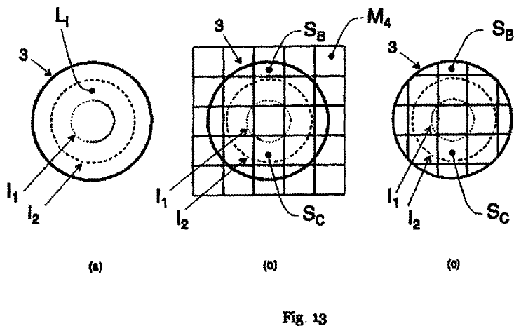

FIG. 13 shows another type of segmentation of a component layer Lᵢ with mainly rectangular segments. To be more precise, FIG. 13 (a) shows the component layer Lᵢ with isolines I₁, I₂ and I₃. In FIG. 13 (b), a pattern M₄ with segments of the same rectangular geometry is shown. SB are those segments that intersect the boundary 3 (“boundary segments”). S_{c} are those segments that lie completely in the interior of the component layer (“core segments”).

Finally, FIG. 13 (c) shows the final segmentation of the component layer.

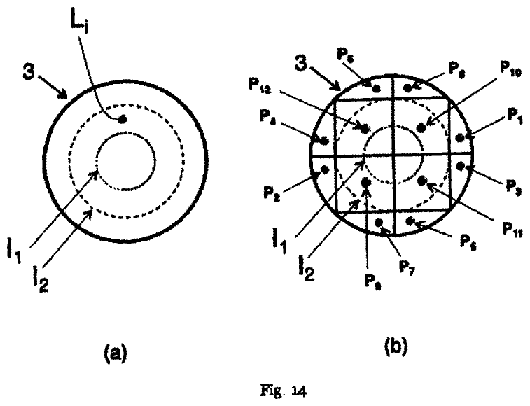

FIG. 14 illustrates a simpler rectangular segmentation and a sequence of the consolidation of individual segments. FIG. 14 (a) shows a component layer Lᵢ with isolines I₁, I₂ and I₃.

FIG. 14 (b) illustrates the segments and their middle points P₁ to P₁₂. The numbers of the middle points indicate the sequence of the consolidation on the basis of the same scheme as in FIG. 10.

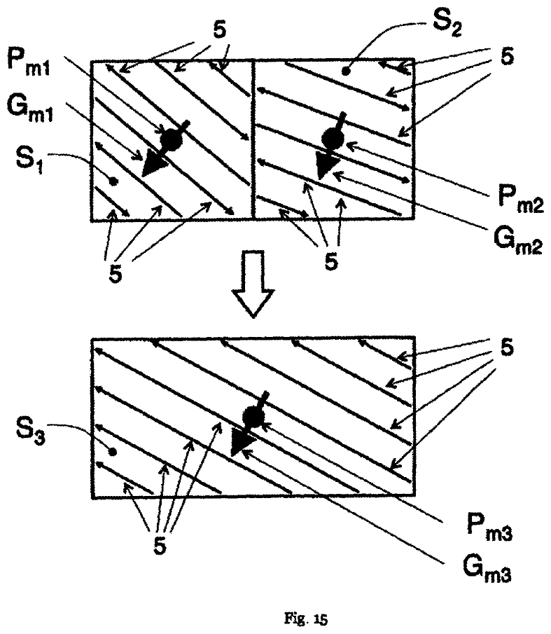

The beginning and end regions of the scanning vectors are known to be less thermally stable, since the heat source is switched on and off in these regions. Often the process defects, such as for example porosity, occur precisely in these regions. It is therefore advisable to reduce the number of beginning and end regions. For this purpose, the merging of the segments is used in the course of the method shown. In FIG. 15, a merging of adjacent segments S₁ and S₂ is shown. At the top of FIG. 15, the two adjacent segments S₁ and S₂ are shown with associated middle points Pₘ₁ and Pₘ₂ and also the gradients Gₘ₁ and Gₘ₂ of the heat dissipating capability and also the scanning vectors 5. In each of these segments there are respectively 6 scanning vectors (12 scanning vectors in total), which have been laid out transversely to the direction of the gradient. At the bottom of FIG. 15, it is shown how a new segment S₃ is produced by a merging of segments S₁ and S₂. Such a merging of the segments is advisable for example whenever the angle between the gradients Gₘ₁ and Gₘ₂ is small. The new segment, the surface area of which represents the sum of the surface areas of the two old segments, thus comprises fewer scanning vectors (8 scanning vectors in the new segment as compared with 12 scanning vectors in the old segments). The number of beginning and end regions is reduced.

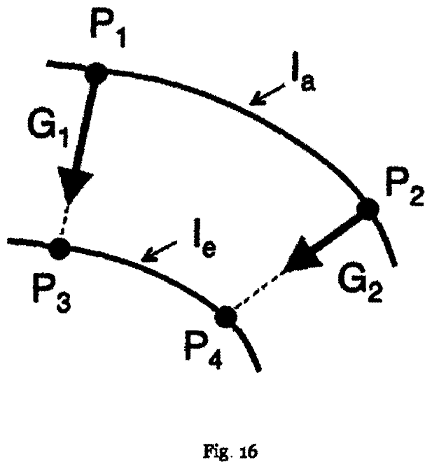

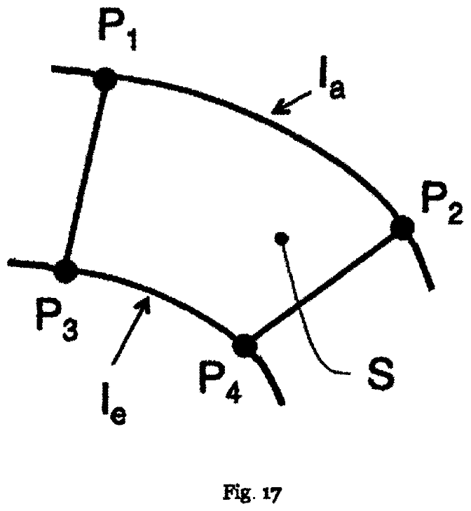

FIG. 16 shows an example of a layout of the bounds of a segment on the basis of the isolines. Iₐ and I_{b} are the isolines of the local heat dissipating capability, P₁ and P₂ are two points on the isoline Iₐ. G₁ and G₂ are gradients of the heat dissipating capability at these points. The points P₃ and P₄ are obtained where the isoline Iₑ crosses the directions of the gradients G₁ and G₂. The resulting segment S is shown in FIG. 17.

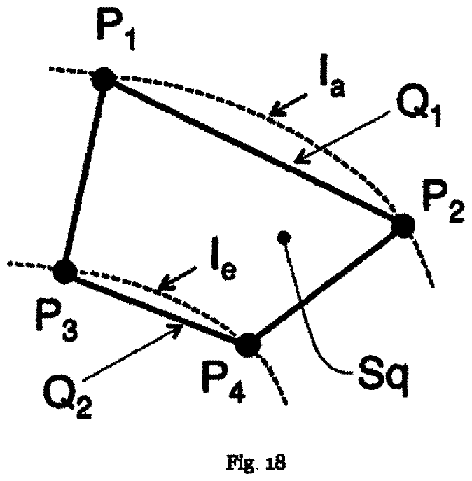

The segment S from FIG. 17 is also modified according to FIG. 18. A new segment S_{q} is created from the segment S. The bounds Q₁ and Q₂ represent one possible type of quasi-isolines Iₐ and Iₑ.

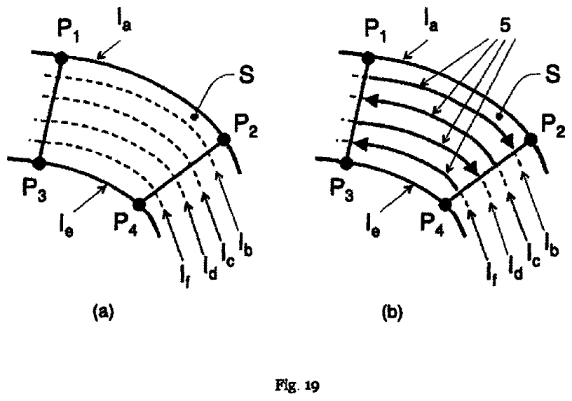

For creating curved scanning vectors within a segment S, they may be laid out on the basis of the isolines I_{b}, I_{c}, I_{d} and I_{f}, which run through the segment S (see FIG. 19).

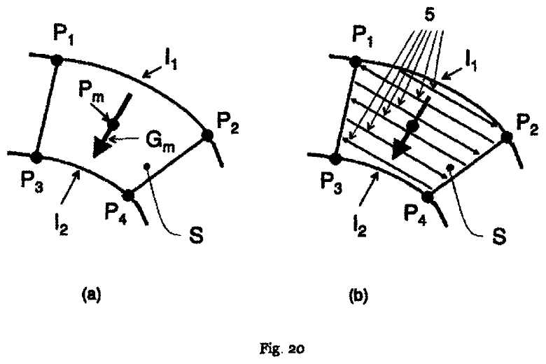

An example of a layout of the scanning vectors within a segment with bounds along the isoline is shown in FIG. 20. Pₘ is the middle point in the segment S. Moreover, the alignment of the gradient Gₘ of the heat dissipating capability at the middle point Pₘ is shown there (see FIG. 20 (a)). In this example, equidistant scanning vectors (scanning vectors) 5 are laid transversely to the alignment of the gradient Gₘ (see FIG. 20 (b)).

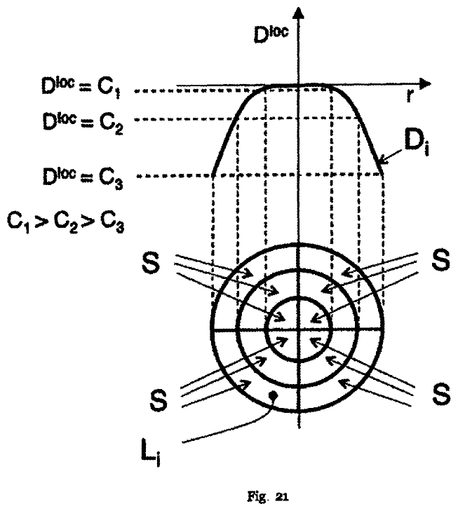

FIG. 21 shows an example of a symmetrical segmentation of the component layer Lᵢ of the component from FIG. 4.

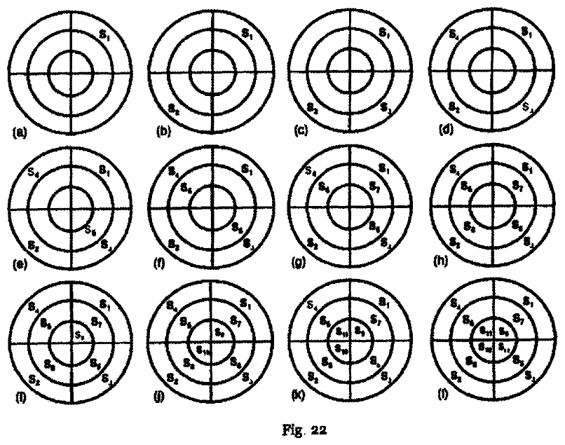

FIG. 22 illustrates a sequence of the consolidation of individual segments of the segmentation shown in FIG. 21 by analogy with FIG. 10.

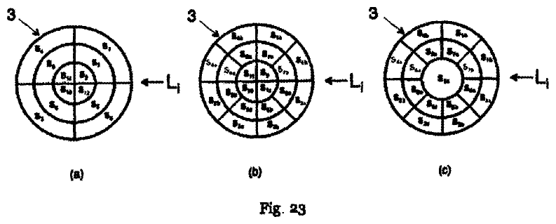

FIG. 23 shows further examples of segmentations of a component layer Lᵢ of the component from FIG. 4, a sequence of the segments and a merging and dividing of the segments. The segmentation has four small-area segments S₉ to S₁₂ in the middle of the component layer Lᵢ, where the value of the local heat dissipating capability is comparable, and relatively large-area segments S₁ to S₉ (see FIG. 23 (a)). The large-area segments S₁ to S₉ in the regions of lower heat dissipating capability are divided. For example, segments S₁ₐ and S_{1b} are obtained from the segment S₁ (see FIG. 23(b)). The small-area segments S₉ to S₁₂ are merged with one another. A single segment S₉ₐ is obtained from the segments S₉, S₁₀, S₁₁, S₁₂ (see FIG. 23 (c)).

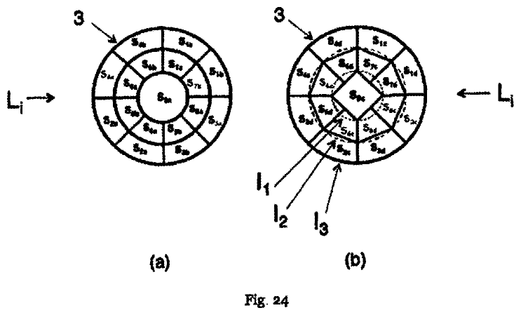

An example of a linearization of the segment bounds is shown in FIG. 24. To be more precise, FIG. 24 (a) shows an original segmentation as in FIG. 23 (c). A new segmentation (see FIG. 24 (b)) is obtained by a linearization of the bounds of the original segments. In this case, the bounds that are not at the boundary 3 of the component layer Lᵢ are linearized

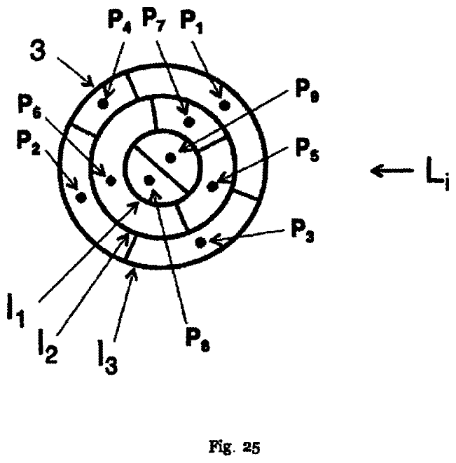

An example of an irregular segmentation of the boundary layer Lᵢ is illustrated by FIG. 25. The numbering of the middle points P₁ to P₉ corresponds to the sequence of the segments. First, the region with the lowest heat dissipating capability is consolidated (segments with the middle points P₁ to P₄). In this case, the first segment with the middle point P₁ is randomly selected. The second segment with the middle point P₂ has the maximum distance from P₁. P₃ has the maximum distance from P₂. P₄ is the last segment in this region (between isolines I₂ and I₃). After that, the segments in the region between the isolines I₁ and I₂ are consolidated. First, the segment with the middle point P₅ is scanned as the segment at the maximum distance away from the middle point P₄. Then, the segment with the middle point P₆ is scanned as the segment at the maximum distance away from P₅. After that, the segment with the middle point P₇ is scanned as the last in this region.

After that, the segments in the region within the isoline I₁ are scanned. First, the segment with the middle point P₈ is scanned as the segment at the maximum distance away from P₇. Then, the segment with the middle point P₉ is scanned as the last in this region.

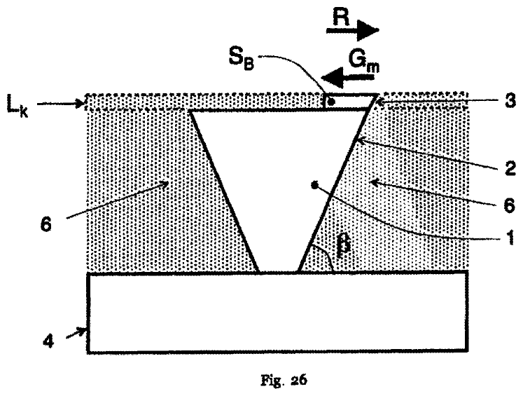

A special case of scanning individual segments according to one particular embodiment of the present invention is shown in FIG. 26. To be more precise, this is a special case of scanning individual segments in the direction counter to the alignment of the gradient Gₘ of the heat dissipating capability. S_{B} is a boundary segment, scanned over an overhang formed by the surface 2. In this case, the boundary 3 of the component layer Lₖ is built using powder 6, but not using already consolidated material. Since the heat dissipating capability increases in the direction of the middle of the component 1, the gradient Gₘ in this segment is aligned toward the middle of the component layer Lₖ. The sequence of the scanning of the individual scanning vectors in this segment is formed in an opposite direction R. As a result of this scanning alignment, a consolidation of the boundary 3 only takes place at the end of the scanning of the entire segment. With a reversed scanning direction, there is the risk that the molten powder in the boundary region is either not bonded or is very poorly bonded to the previous solid layer. Poor bonding is to be expected in particular with lower angles β. On account of the poor bonding to the solid material of the previous component layer, the heat flux into the interior of the component is prevented. This will cause an accumulation of heat, and possibly great deformation of the segment, at the boundary 3 or in the boundary region.

For the sake of completeness, it is also pointed out with regard to FIG. 26 that a building plate 4 is also shown in it.

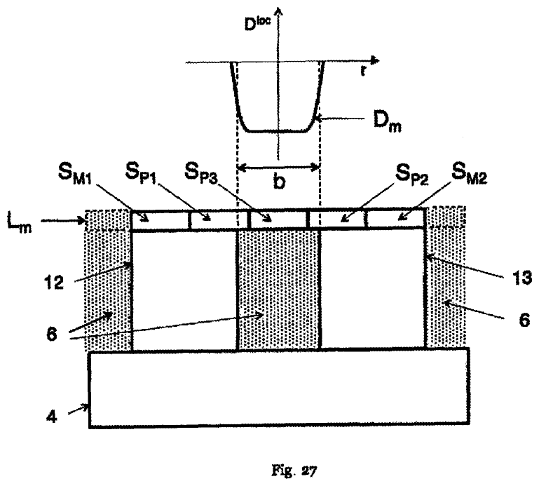

FIG. 27 shows a special case of the sequence of the scanning of individual segments in the direction of the lessening of the local heat dissipating capability. It may be advisable to consolidate the segments that are fully or partially consolidated using powder (such as the segments S_{P1}, S_{P2} and S_{P3} (“P” denotes “using powder”)) in the direction of lessening heat dissipating capability. The sequence of the segments in the example shown: first S_{P1} and S_{P2} and only then S_{P3}. With a reversed sequence (for example S_{P3} and then S_{P1} or S_{P2}), there is the risk of unstable layer formation, since the segment S_{P3} is built as a “solid island” using powder and is not bonded to any “mainland”. The heat cannot in this case be transported further into the interior of the component. Such an “island” may be very greatly deformed as a result of uneven cooling down (distortion). For the same reasons, it may also be advisable to carry out the scanning of individual segments, such as for example S_{P1}, S_{P2} and S_{P3}, in the direction opposite to the gradient, as is shown in FIG. 26. The “normal” segments with the solid, already consolidated material of the previous component layer on the lower side, such as segments S_{M1} and S_{M2} (“M” denotes “using solid material”) are also scanned “normally”, that is to say in the direction of the gradient of the thermal conductivity. The sequence of these segments should preferably also remain “normal”, that is to say they are consolidated first in the regions with a lower heat dissipating capability and then in the regions with a higher heat dissipating capability.

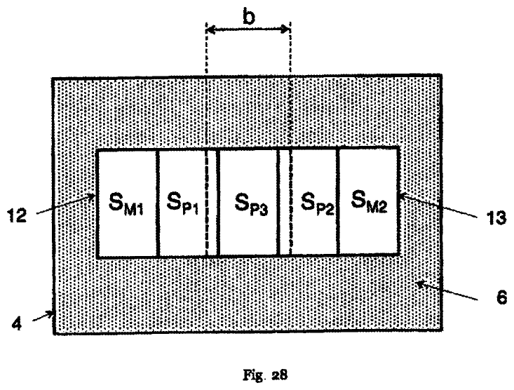

FIG. 28 shows a layer from above for the example from FIG. 27.

It goes without saying that the sequences described above may be altered, reduced or supplemented.

The features of the invention disclosed in the above description, in the drawings and in the claims may be essential for implementing the invention in its various embodiments both individually and in whatever combinations are desired.

### LIST OF DESIGNATIONS

1 Component
2 Surface
3 Outer boundary
4 Building plate
5 Scanning vectors
6 Powder
10 Edge
30, 31, 32 Segments
40, 41, 42 Scanning vectors
50, 51, 52 Laser beams
60 Scanner
αₘᵢₙ Angle
C₁, C₂, C₃ Constants
Dᵢ Local distribution of the heat dissipating capability
d₁ Upper diameter
d₂ Lower diameter
dᵥ Offset
G₁, G₂ Gradients
Gₘ, Gₘ₁, Gₘ₂, Gₘ₃ Gradients
I₁, I₂, I₃ Isolines of the heat dissipating capability
Iₐ, I_{b}, . . . I_{f} Isolines
Lᵢ, Lₖ Component layer
M Material
M₄, M₆ Patterns
P₁, P₂, . . . P₁₂ Middle points
Pₘ, Pₘ₁, Pₘ₂, Pₘ₃ Middle points
P_{S1}, P_{S2}, . . . , P_{S6} Middle points
Q₁, Q₂ Bounds
R Direction
S₁, S₂, . . . S₁₂ Segments
S₁ₐ, S_{1b} Segments
S₉ₐ Segments
S_{b}, S_{c}, S_{q} Segments
S_{M1}, S_{M2} Segments
S_{P1}, S_{P2}, S_{P3} Segments
V₁, V₂ . . . ; V₈ Scanning vectors

1. A method for additively manufacturing a three-dimensional component (1) from multiple component layers (Lᵢ, Lₖ) by repeated incremental addition, in particular in layers, of a component starting material, in particular a metallic component starting material, in the form of a powder, wire or strip, and, in particular incremental, shaping consolidation of the component starting material by respectively selective melting and/or sintering by means of an amount of heat introduced by at least one energy source, in particular locally, according to a scanning strategy, wherein the method comprises dividing each of the component layers (Lᵢ, Lₖ) into segments (S₁, S₂, S₃, . . . , S₁₂), wherein at least one of
the division of a component layer into segments, a time sequence of the creation of individual segments, a layout of scanning vectors within a segment, and a time sequence of the scanning vectors within a segment in the creation of respective segmented component layers (Lᵢ, Lₖ),
takes place on the basis of a determined local heat dissipating capability, in particular determined in a simulation-based manner, or on the basis of a function of the same in a respective component layer.

2. The method as claimed in claim 1, wherein a respective component layer (Lᵢ, Lₖ) is segmented into polygonal segments, in particular rectangular or hexagonal segments.

3. (canceled)

4. (canceled)

5. The method as claimed in claim 1, wherein one of the values of the local heat dissipating capability within the respective segment, in particular an average value of the local heat dissipating capability, in each of the segments is used as a reference value of the local heat dissipating capability.

6. The method as claimed in claim 5, wherein the sequence of the creation of individual segments is chosen on the basis of the reference values of the local heat dissipating capability.

7. The method as claimed in claim 6, wherein the segments are created starting from segments with a low reference value of the local heat dissipating capability progressively to segments with a higher reference value of the local heat dissipating capability.

8. (canceled)

9. (canceled)

10. (canceled)

11. (canceled)

12. (canceled)

13. The method as claimed in claim 5, wherein the segments of a component layer are divided into at least two groups according to the reference value of the local heat dissipating capability in the respective segments.

14. The method as claimed in claim 13, wherein a respective group of segments is formed from those segments of which the reference value of the local heat dissipating capability lies within a specific interval between two constant limit values of the local heat dissipating capability.

15. The method as claimed in claim 14, wherein, for each group of segments, a reference value, in particular an average value, of the local heat dissipating capability is determined.

16. The method as claimed in claim 15, wherein the sequence for creating individual groups is chosen on the basis of the reference value of the local heat dissipating capability of the respective group.

17. The method as claimed in claim 16, wherein the groups are created starting from groups with a low reference value of the local heat dissipating capability progressively to groups with a higher reference value of the local heat dissipating capability.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. The method as claimed in claim 1, wherein the component layer is created with the aid of a number of energy sources acting at the same time at different locations of the component layer, in particular with a number of lasers or with a light source split between different locations.

30. The method as claimed in claim 29, wherein at least one pair of successive segments is created at the same time from the determined sequence of the creation of the segments with the aid of at least two different energy sources.

31. (canceled)

32. The method as claimed in claim 1, wherein, in each of the segments the direction of the gradient of the local heat dissipating capability, preferably at the middle point of the respective segment, is used as a reference direction of the gradient of the local heat dissipating capability.

33. The method as claimed in claim 32, wherein the direction of the scanning vectors in a respective segment is laid out transversely to the reference direction of the gradient of the local heat dissipating capability.

34. The method as claimed in claim 32, wherein in a respective segment an edge of this segment of which the normal vector has the smallest deviation from the reference direction of the gradient of the local heat dissipating capability is determined as the normal vectors of the other edges of this segment, and the scanning vectors are laid out parallel to this edge, preferably equidistanly equidistantly.

35. The method as claimed in claim 32, wherein the sequence of the scanning of the individual scanning vectors within a segment is chosen on the basis of the reference direction of the gradient of the local heat dissipating capability.

36. The method as claimed in claim 35, wherein the offset between two successive scanning vectors within a segment takes place in a reference direction of the gradient of the local heat dissipating capability.

37. (canceled)

38. The method as claimed in claim 35, wherein the offset between two successive scanning vectors within a segment takes place counter to a reference direction of the gradient of the local heat dissipating capability.

39. The method as claimed in claim 38, wherein the time interval between successive scanning vectors is successively increased.

40. A method for calculating a scanning strategy for the corresponding control of a system for additively manufacturing a three-dimensional component, wherein at least one of a division of a component layer into segments, a time sequence of the creation of individual segments, a layout of the scanning vectors within a segment, and/or the time sequence of the scanning vectors within a segment, takes place on the basis of a determined local heat dissipating capability, in particular determined in a simulation-based manner, or on the basis of a function of the same in a respective component layer.

41. A system for additively manufacturing a three-dimensional component from multiple component layers by repeated incremental addition, in particular in layers, of a component starting material, in particular a metallic component starting material, in the form of a powder, wire or strip, and, in particular incremental, shaping consolidation of the component starting material by respectively selective melting and/or sintering by means of an amount of heat introduced by at least one energy source, in particular locally, according to a scanning strategy, comprising
a building space housing with a building platform for supporting one or more component/components to be additively manufactured in a powder-bed-based manner,
a layer preparation device for preparing respective powder layers on the building platform,
an irradiating device for irradiating the respectively last-prepared powder layer on the building platform and
a control device for controlling the irradiating device according to a method for additively manufacturing a three-dimensional component (1) from multiple component layers (Lᵢ, L_{K}) by repeated incremental addition, in particular in layers, of a component starting material, in particular a metallic component starting material, in the form of a powder, wire or strip, and, in particular incremental, shaping consolidation of the component starting material by respectively selective melting and/or sintering by means of an amount of heat introduced by at least one energy source, in particular locally, according to a scanning strategy, wherein the method comprises dividing each of the component layers (Lᵢ, Lₖ) into segments (S₁, S₂, S₃, . . . , S₁₂), wherein at least one of
the division of a component layer into segments, a time sequence of the creation of individual segments, a layout of scanning vectors within a segment, and a time sequence of the scanning vectors within a segment in the creation of respective segmented component layers (Lᵢ, Lₖ),
takes place on the basis of a determined local heat dissipating capability, in particular determined in a simulation-based manner, or on the basis of a function of the same in a respective component layer.

42. A computer-readable medium/media which comprise(s) commands which can be executed by computer and, when they are executed by a computer, make the computer carry out at least one of:
a) a method for additively manufacturing a three-dimensional component (1) from multiple component layers (Lᵢ, Lₖ) by repeated incremental addition, in particular in layers, of a component starting material, in particular a metallic component starting material, in the form of a powder, wire or strip, and, in particular incremental, shaping consolidation of the component starting material by respectively selective melting and/or sintering by means of an amount of heat introduced by at least one energy source, in particular locally, according to a scanning strategy, wherein the method comprises dividing each of the component layers (Lᵢ, L_{K}) into segments (S₁, S₂, S₃, . . . , S₁₂), wherein at least one of
the division of a component layer into segments, a time sequence of the creation of individual segments, a layout of scanning vectors within a segment, and a time sequence of the scanning vectors within a segment in the creation of respective segmented component layers (Lᵢ, Lₖ),
takes place on the basis of a determined local heat dissipating capability, in particular determined in a simulation-based manner, or on the basis of a function of the same in a respective component layer; and
b) a method for calculating a scanning strategy for the corresponding control of a system for additively manufacturing a three-dimensional component, wherein at least one of a division of a component layer into segments, a time sequence of the creation of individual segments, a layout of the scanning vectors within a segment, the time sequence of the scanning vectors within a segment, takes place on the basis of a determined local heat dissipating capability, in particular determined in a simulation-based manner, or on the basis of a function of the same in a respective component layer.
